(19) United States
(12) Patent Application Publication
(10) Pub. No.: US 2004/0010086 A1
(43) Pub. Date: Jan. 15, 2004

(54) Low temperature impact resistant polyolefin alloys

(76) Inventors: Deenadayalu Chundury, Newburgh, IN (US); Roy C. Sanford, Dale, IN (US); Matthew R. Powell, Ballston Spa, NY (US); Larry N. Trotter, Stephens City, VA (US)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/194,943

(22) Filed: Jul. 12, 2002

(51) Int. Cl. C08L 23/00

(52) U.S. Cl. 525/240; 524/321; 524/394; 524/303

(57) ABSTRACT

The present invention provides a TPO blend that exhibits surprisingly excellent low temperature impact resistance. The TPO blend according to the invention includes a polyolefin, a metallocene catalyzed olefinic copolymer plastomer and a lubricant package. The lubricant package includes a mixture of an internal lubricant and an external lubricant. In the preferred embodiment of the invention the polyolefin is polypropylene, the metallocene catalyzed olefinic copolymer is a metallocene catalyzed low density ethylene-octene copolymer, and the lubricant package includes a blend of ethylene bis-stearamide wax as an external lubricant and calcium stearate wax as an internal lubricant. The TPO blend according to the invention also preferably comprises optional antioxidants, UV stabilizers, and colorants. The TPO blend according the present invention is particularly well suited for use in forming injection molded polymeric articles such as very large and complex automotive exterior components, but can be used to form a variety of injection molded articles.

### FIELD OF INVENTION

The present invention relates to polyolefin alloys. More particularly, the present invention relates to thermoplastic polyolefin alloys useful for forming injection molded polymeric articles such as automotive exterior and interior components that exhibit excellent low temperature impact resistance.

### BACKGROUND OF THE INVENTION

A wide variety of polyolefin alloys are known in the art. Thermoplastic polyolefin alloy blends, which are referred to in the art as “TPO blends”, typically comprise a mixture of a polyolefin such as polypropylene, an olefinic copolymer elastomer, and various optional stabilizers, performance additives, colorants, fillers and fibers. Generally speaking, TPO blends are multiphase polymer systems in which the polyolefin comprises the continuous (or matrix) phase, and the olefinic copolymer elastomer comprises the dispersed (or minor) phase. The polyolefin matrix provides good tensile strength, rigidity and chemical resistance, whereas the minor phase olefinic copolymer elastomer provides with flexibility, resilience and low temperature toughness.

TPO blends are particularly well suited for use in forming injection molded polymeric articles such as automotive exterior and interior components. Examples include bumper fascia, dashboards, step pads, air dams and other automotive trim parts. The low temperature impact resistance of TPO blends used in such applications is very important. Although improvements in low temperature impact resistance have been achieved in some TPO blends in recent years, such improvements have typically resulted in a substantial increase in material cost, have required the use of complex compounding conditions that lower equipment through-put rates, multiple processing steps and/or longer (undesirable) molding cycles.

### BRIEF SUMMARY OF THE INVENTION

The present invention provides a TPO blend that exhibits surprisingly excellent and (lot to lot) consistent low temperature impact resistance. The TPO blend according to the invention comprises a polyolefin, a metallocene catalyzed olefinic copolymer plastomer and a synergistic lubricant package comprising a mixture of an internal lubricant and an external lubricant. In the preferred embodiment of the invention the polyolefin comprises polypropylene, the metallocene catalyzed olefinic copolymer plastomer comprises a metallocene catalyzed low density ethylene-octene copolymer, and the lubricant package comprises a blend of ethylene bis-stearamide wax as an external lubricant and calcium stearate wax as an internal lubricant. Preferably, the external lubricant and internal lubricant are used at a 50/50 weight ratio. The TPO blend according to the invention also preferably comprises optional antioxidants, UV stabilizers, colorants, fillers and/or fibers. The TPO blend according the present invention is particularly well suited for use in forming injection molded polymeric articles such as very large and complex automotive exterior components, but can be used to form a variety of other injection molded articles. In addition, the TPO blend according to the invention can be custom formulated for extrusion applications.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a load vs. time-to-failure curve for five plaques formed from a conventional TPO blend composition.

FIG. 2 is a photograph of a plaque formed from a conventional TPO blend composition after multi-axial impact strength testing.

FIG. 3 is a load vs. time-to-failure curve for five plaques formed from a TPO blend composition according to the invention.

FIG. 4 is a photograph of a plaque formed from a TPO blend composition according to the invention after multi-axial impact testing.

### DETAILED DESCRIPTION OF THE INVENTION

The present invention provides a thermoplastic olefin blend (“TPO blend”) composition that exhibits excellent low temperature impact resistance. The thermoplastic olefin blend composition according to the invention comprises a major amount by weight of a polyolefin, a minor amount by weight of a metallocene catalyzed olefinic copolymer plastomer and a lubricant package comprising a blend of an external lubricant and an internal lubricant. Throughout the instant specification and in the appended claims, the term “major amount” means 50% or more by weight, and the term “minor amount” means less than 50% by weight.

The polyolefin used in the thermoplastic olefin blend composition according to the invention is preferably polypropylene, and more preferably a homopolymer of polypropylene, although copolymers of polypropylene and/or other olefins can also be used. Homopolymers of polypropylene having a melt flow index of about 10 to about 14, and most preferably about 12, are particularly suitable for use in the invention because they are well suited to injection molding operations. The homopolymers or copolymers of polypropylene used in the blend are preferably semi-crystalline homopolymers or copolymers of polypropylene having a number average molecular weight above about 10,000, and more preferably above about 50,000.

As previously noted, the blend comprises a major amount of a polyolefin. More preferably, the blend comprises from about 55% to about 75% by weight, and more preferably about 60% to about 70% by weight, of one or more polyolefins, most preferably polypropylene.

The metallocene catalyzed olefinic copolymer plastomer used in the thermoplastic olefin blend composition according to the invention is preferably a metallocene catalyzed low density ethylene-octene copolymer. A variety of such copolymers are available from Dupont Dow Elastomers LLC under the ENGAGE® trademark. Metallocene catalyzed low density ethylene-octene copolymers having melt flow indicies from about 0.5 to about 3.0, and more preferably about 1.0, and densities from about 0.85 to about 0.9, and more preferably about 0.865, are particularly suitable for use in the invention.

As previously noted, the blend comprises a minor amount of one or more metallocene catalyzed olefinic copolymer plastomer. More preferably, the blend comprises from about 20% to about 40% by weight, or more preferably from about 25% to about 35% by weight, of one or more metallocene catalyzed olefinic copolymer plastomers, most preferably one or more metallocene catalyzed ethylene-octene copolymers.

The lubricant package according to the invention comprises a blend of an external lubricant and an internal lubricant. An internal lubricant is an additive that promotes resin flow without affecting fusion properties. At conventional loadings, internal lubricants do not contribute significantly to metal release properties. External lubricants provide metal mold release properties. An external lubricant will generally have a relatively low compatibility with the polymer, and a high affinity for the metal mold surface. During injection molding operations, the external lubricant will migrate to and form a film at the interface between the polymer melt and the metal, providing the mold release properties.

Applicants have discovered that incorporation of both an external lubricant and an internal lubricant at a relatively high loading in a thermoplastic olefin alloy composition tends to improve significantly the low temperature impact resistance of injection-molded parts formed from the thermoplastic olefin blend composition. Those having skill in the art will recognize that there are a variety of external lubricants and internal lubricants. The presently most preferred external lubricant for use in the invention is ethylene-bis stearamide wax. The presently most preferred internal lubricant for use in the invention is calcium stearate wax.

The amount of external lubricants and internal lubricants incorporated into the blend is preferably the least amount effective to obtain the improved low temperature impact resistance. Amounts of from about 0.25% to about 2.0% by weight are typically sufficient, with amounts of about 0.5% by weight being presently most preferred. The weight ratio of external lubricant to internal lubricant in the lubricant package can range from about 20:80 to about 80:20, but a 50:50 weight ratio is presently most preferred.

The inclusion of a combination of an internal lubricant and an external lubricant in the TPO blend according to the invention also substantially reduces the likelihood that an injection molded part will stick to the mold. Accordingly, the use of spray-on mold release agents is not necessary, which provides additional savings in terms of time and expense. The TPO blend composition according to the invention also offers improved cycle times, which is a value-added benefit to injection molders.

The thermoplastic olefin blend composition according to the present invention can further comprise optional antioxidants, UV stabilizers, colorants and fillers, as are well known in the art. Preferred antioxidants include combinations of hindered phenolic primary antioxidants and thioester secondary antioxidants. Preferred UV stabilizers include hindered amine type UV stabilizers and accompanying synergists. Colorants can include pigments and organic dyes, with carbon black dispersed in a polymeric carrier being presently most preferred. Fillers such as talc, calcium carbonate and various fibers can also be incorporated into the thermoplastic olefin blends as desired. Preferably such optional antioxidants, UV stabilizers, colorants and fillers are present in an amount less than about 15% by weight.

The following examples are intended only to illustrate the invention and should not be construed as imposing limitations upon the claims. Unless otherwise indicated in the following examples and elsewhere in the specification and claims, all parts and percentages are by weight, temperatures are in degrees centigrade and pressures are at or near atmospheric.

### EXAMPLE 1

Thermoplastic Olefin Blend Compositions A and B (“TPO-A” and “TPO-B”, respectively) were each separately prepared by compounding the various components shown in weight percent in Table 1 below in a standard compounding single screw extruder with typical strand die, cool water bath and pelletizer. TPO-A was a control (i.e., not in accordance with the present invention). TPO-B is the presently most preferred embodiment of the present invention.

TABLE 1

| | BRAND OR | | |
|---|---|---|---|
| COMPONENT | TYPE | TPO - A | TPO - B |
| Polypropylene Homopolymer, | Equistar | 65.9100 | 65.4100 |
| 12 Melt Flow Index | 51S12a | | |
| Metallocene Based PE | Dupont Dow | 30.0000 | 30.0000 |
| Plastomer, 1 Ml 0.86 g/cc | POE 8999 | | |
| Primary Hindered Phenolic | Ciba Irganox | 0.0225 | 0.0225 |
| Antioxidant | 3114 | | |
| Secondary antioxidant | DSTDP Flake | 0.0675 | 0.0675 |
| (distearyl thiodipropionate) | | | |
| Hindered Amine UV | Ciba Tinuvin | 0.6000 | 0.6000 |
| Stabilizer | 770 | | |
| Hindered Amine UV | Ciba Chemabsorb | 0.4000 | 0.4000 |
| Stabilizer/Synergist | 944 | | |
| External Lubricant (ethylene | Acme Hardesty, | — | 0.2500 |
| bis-stearamide wax) | EBS Wax | | |
| Internal Lubricant (calcium | Ferro Calcium | — | 0.2500 |
| stearate wax) | Stearate | | |
| Carbon Black Masterbatch | H. Heller, | 3.0000 | 3.0000 |
| (LDPE as carrier) | 718-5 Black | | |

| | | |
|---|---|---|
| Total | 100.0000 | 100.0000 |

### EXAMPLE 2

The TPO-A and TPO-B pellets formed in Example 1 were separately fed into a Newbury injection molding machine and molded into plaques having the following dimensions: 6″ long×4″ wide×⅛″ thick. The temperature profile of the molding machine was set at 205° C. in Zones 1-3 and at the nozzle, and the actual temperature was maintained to within ±3% of the set temperature. The mold temperature was set and maintained at 60° C. TPO-A had a melt flow index of 9.8, whereas TPO-B had a melt flow index of 6.0. A total of five plaques each of TPO-A and TPO-B were formed. The plaques were removed from the mold and allowed to stand for 40 hours in ambient conditions (˜23.5° C., ˜50% relative humidity).

### EXAMPLE 3

After 40 hours, the plaques produced in Example 2 were subjected to multi-axial impact strength testing at −30° C. in accordance with the ASTM D3763 standard using a Dynatup model 8250. A weight of 25 pounds and a speed of 15 miles per hour were used to measure the failure mode and the total energy. The weight was adjusted such that the velocity slowdown was less than 20%.

In accordance with ASTM D3763, the failure mode was defined as ductile (D) if the load vs. time-to-failure curve was symmetric and there were no radial cracks in the sample and the tup pierced through the sample. The ductile-brittle (DB) failure mode was defined as the mode where on the load vs. time-to-failure curve, the load went through the maximum, and suddenly dropped to zero and there were radial cracks in the sample. And, brittle-ductile (BD) failure mode was defined as the condition where in the load vs. time-to-failure curve, the load fell well before reaching a maximum and the sample broke into multiple pieces. The desirable failure mode is completely ductile at the specified temperatures.

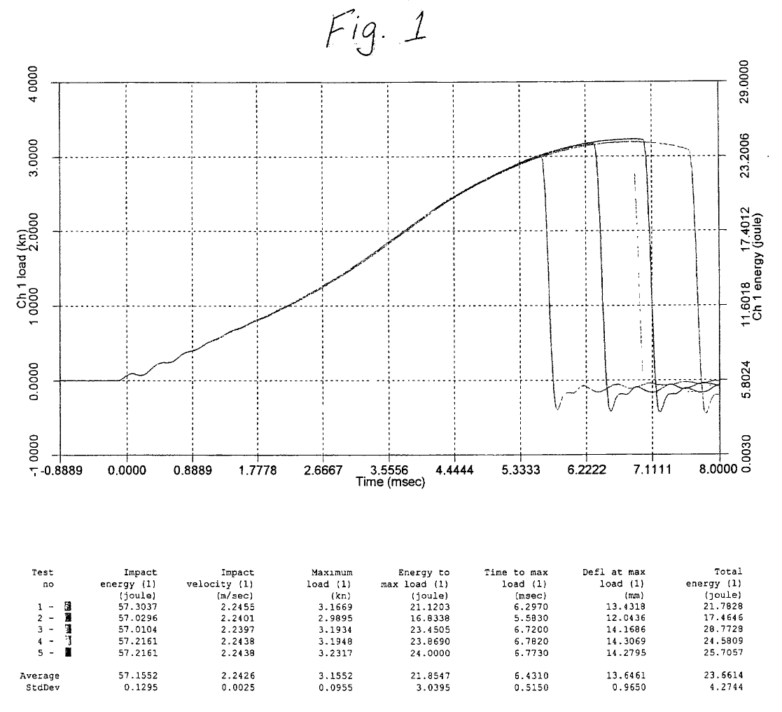

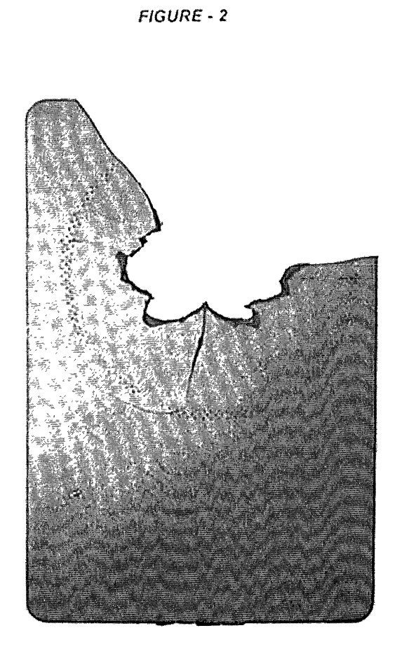

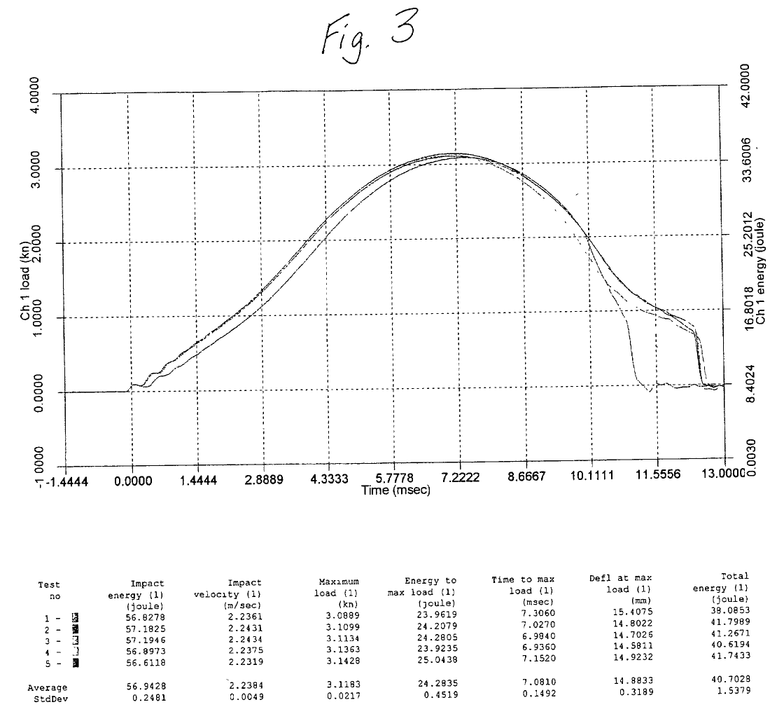

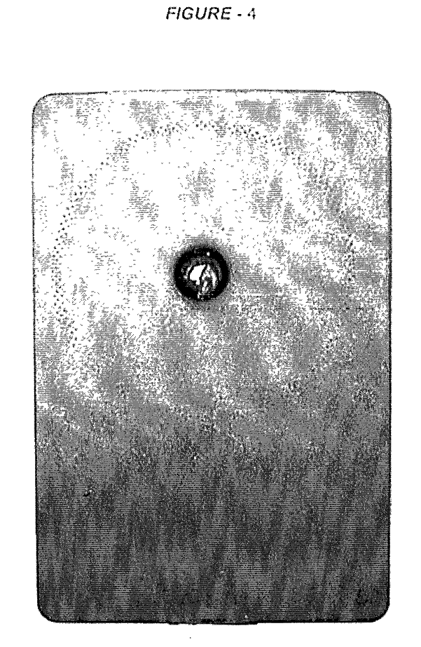

FIG. 1 shows the load vs. time-to-failure curve for five plaques formed from TPO-A. FIG. 2 is a photograph of a plaque formed from TPO-A after multi-axial impact strength testing. FIG. 3 shows the load vs. time-to-failure curve for five plaques formed from TPO-B. FIG. 4 is a photograph of a plaque formed from TPO-B after multi-axial impact strength testing.

As is evident from FIGS. 1 through 4, the plaques formed from TPO-A exhibited a brittle-ductile failure mode at −30° C. whereas the plaques formed from TPO-B exhibited a completely ductile failure mode. In addition, the plaques formed from TPO-A showed a substantial standard deviation in the area under the curve, whereas the plaques formed from TPO-B had a very small standard deviation, which is desired. Surprisingly, the addition of only 0.500% by weight of a 50:50 (w/w/) mixture of an internal lubricant and an external lubricant to the control TPO formula resulted in a substantial improvement in low temperature impact resistance of the injection molded plaque.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A thermoplastic olefin blend composition comprising a major amount by weight of a polyolefin, a minor amount by weight of a metallocene catalyzed olefinic copolymer plastomer and a lubricant package comprising a blend of an external lubricant and an internal lubricant.

2. The thermoplastic olefin blend composition according to claim 1 wherein the external lubricant comprises ethylene-bis stearamide wax.

3. The thermoplastic olefin blend composition according to claim 1 wherein the internal lubricant comprises calcium stearate wax.

4. The thermoplastic olefin blend composition according to claim 1 wherein the polyolefin comprises polypropylene.

5. The thermoplastic olefin blend composition according to claim 1 wherein the metallocene catalyzed olefinic copolymer plastomer comprises a metallocene catalyzed ethylene-octene copolymer.

6. The thermoplastic olefin blend composition according to claim 1 further comprising a up to about 0.5% by weight of a mixture of a hindered phenolic primary antioxidant and a thioester secondary antioxidant.

7. The thermoplastic olefin blend composition according to claim 1 further comprising a UV stabilizer.

8. The thermoplastic olefin blend composition according to claim 1 further comprising a colorant.

9. A thermoplastic olefin blend composition comprising:
from about 55% to about 75% by weight of polypropylene;
from about 20% to about 40% by weight of a metallocene catalyzed ethylene-octene copolymer;
up to about 2.0% by weight of a lubricant package comprising a blend of an external lubricant and an internal lubricant; and
up to about 15% by weight of optional additives selected from the group consisting of antioxidants, UV stabilizers, colorants, and fillers.

10. The thermoplastic olefin blend composition according to claim 9 wherein the external lubricant comprises ethylene-bis stearamide wax and the internal lubricant comprises calcium stearate wax.

11. The thermoplastic olefin blend composition according to claim 9 comprising:
about 65.4% by weight of polypropylene;
about 30% by weight of the metallocene catalyzed ethylene-octene copolymer;
about 0.5% by weight of the lubricant package;
about 0.1% by weight of one or more antioxidants;
about 1.0% by weight of one or more UV stabilizers; and
and about 3.0% by weight of one or more colorants.

12. The thermoplastic olefin blend composition according to claim 11 wherein the external lubricant in the lubricant package comprises ethylene-bis stearamide wax and the internal lubricant in the lubricant package comprises calcium stearate wax.

13. The thermoplastic olefin blend composition according to claim 11 wherein the antioxidants comprise a blend of hindered phenolic primary antioxidants and thioester secondary antioxidants.

14. The thermoplastic olefin blend composition according to claim 11 wherein the colorants comprise carbon black dispersed in a polymeric carrier.
